(19) United States
(12) Patent Application Publication
(10) Pub. No.: US 2014/0096153 A1
(43) Pub. Date: Apr. 3, 2014

(54) SATELLITE COMMUNICATION SYSTEM AND METHOD BASED ON DIGITAL VIDEO BROADCASTING-RETURN CHANNEL VIA SATELLITE (DVB-RCS)

(71) Applicant: Electronics and Telecommunications Research Institute, (US)

(72) Inventor: Do Huy WANG, Seoul (KR)

(73) Assignee: Electronics and Telecommunications Research Institute, Daejeon (KR)

(21) Appl. No.: 13/845,241

(22) Filed: Mar. 18, 2013

(30) Foreign Application Priority Data
Sep. 28, 2012 (KR) 10-2012-0108467

(51) Int. Cl. H04N 21/61

(52) U.S. Cl. CPC H04N 21/6193
USPC 725/25

(57) ABSTRACT

A satellite communication system and method based on a digital video broadcasting-return channel via satellite (DVB-RCS) are provided. The satellite communication system may include a central station, and at least one very small aperture terminal (VSAT) including a first VSAT and a second VSAT. When a logon request is received from the second VSAT, the central station may determine whether the first VSAT is normally operated. When the first VSAT is determined to be abnormally operated, the central station may allow the second VSAT to log onto the central station.

### CROSS-REFERENCE TO RELATED APPLICATION

This application claims the benefit of Korean Patent Application No. 10-2012-0108467, filed on Sep. 28, 2012, in the Korean Intellectual Property Office, the disclosure of which is incorporated herein by reference.

### BACKGROUND

1. Field of the Invention

The present invention relates to a technology for improving stability of a link by installing, in a corresponding site, very small aperture terminals (VSATs) for satellite communication in a duplex configuration, to minimize service interruption due to unstable links, errors in terminals, and the like, in a satellite communication system based on a digital video broadcasting-return channel via satellite (DVB-RCS).

2. Description of the Related Art

Currently, satellite communication enabling subscribers located in a distant place to make a call through a satellite is becoming increasingly common.

Satellite communication refers to a long-distance communication technology in which a satellite functions as a relay station, and is a communication scheme of relaying communication using a satellite launched into outer space.

When satellite communication is used, a communicable zone may be widened, and ultrahigh-speed transmission using a radio wave in a high-frequency band may be enabled. Satellites include, for example, a stationary satellite that looks as if the stationary satellite remains stationary above the earth orbit while revolving the earth at a speed corresponding to the rotation time of the earth. In satellite communication, the stationary satellite may be mainly used.

Since a microwave is used in satellite communication, high-speed, large capacity communication may be enabled, and a wide area (for example, the whole area of a specific country, and the like) may be included within a radius of communication.

Additionally, satellite communication may be enabled regardless of geographical features, and there is no constraint of communication despite occurrence of a disaster. However, satellite communication has disadvantages in that radio waves are delayed when voice communication is performed for a round trip time of radio waves (for example, about 0.24 seconds), and in that there is no security of information.

In addition, since a solar cell is used as a power source in satellite communication, communication may be momentarily interrupted when a satellite is located in a shade of the earth or when heavy rain falls.

Since a separate signal line for calling is not required in satellite communication using a frequency in a band higher than a short wave band passing through the ionosphere, the satellite communication is usefully used as long-distance communication between countries or mountainous regions, for example South Korea.

Additionally, recently, satellite communication is widely used as international communication, domestic long-distance communication, marine/aeronautical mobile communication, and the like.

Initially, satellite communication was used for international telephone calls or television relay, due to high-priced satellites. However, based on technical improvement and cost reduction, the satellite communication is being applied in various shapes using features of the satellite communication. For example, the satellite communication may be applied to data communication, collection of remote data, communication between personal computers (PC), Internet communication, image program distribution, such as composite cable broadcasting (for example, cable televisions (CATVs)) and the like, a distance education, communication within companies, personal circuits, remove video conferences, newspaper transmission, satellite news gathering (SNG), relay of various events, and the like.

### SUMMARY

According to an aspect of the present invention, there is provided a satellite communication system based on a digital video broadcasting-return channel via satellite (DVB-RCS), the satellite communication system including: a central station; and at least one very small aperture terminal (VSAT) including a first VSAT and a second VSAT, wherein, when a logon request is received from the second VSAT, the central station determines whether the first VSAT is normally operated, and when the first VSAT is determined to be abnormally operated, the central station allows the second VSAT to log onto the central station.

The central station may include a link control processor to receive a logon request from the at least one VSAT.

When the logon request is received, the link control processor may determine whether a VSAT that is logged onto the central station in advance is normally operated.

The link control processor may check a logon state of the at least one VSAT. When a VSAT logged onto the central station does not exist, the link control processor may transmit a wake-up command to each of the at least one VSAT.

The link control processor may set different Internet protocols (IPs) to the at least one VSAT, and may perform a switching function.

The central station may include a packet data processor to transform received data to a moving picture experts group-transport stream (MPEG-TS), using a media access control (MAC) address corresponding to a currently logged-on VSAT.

According to another aspect of the present invention, there is provided a satellite communication method based on a DVB-RCS, the satellite communication method including: receiving a logon request from a second VSAT; determining whether a first VSAT is normally operated, in response to the logon request; and allowing the second VSAT to log onto a central station, when the first VSAT is determined to be abnormally operated.

The satellite communication method may further include rejecting the logon request, and maintaining a logon state of the first VSAT, when the first VSAT is determined to be normally operated.

According to another aspect of the present invention, there is provided a satellite communication method based on a DVB-RCS, the satellite communication method including: checking a logon state of each of a plurality of VSATs corresponding to a central station; determining whether a VSAT logged onto the central station exists among the plurality of VSATs; and transmitting a wake-up command to each of the plurality of VSATs, when the logged-on VSAT is determined not to exist.

The satellite communication method may further include maintaining a current state of each of the plurality of VSATs, when the logged-on VSAT is determined to exist.

The satellite communication method may further include transforming received data to an MPEG-TS, using a MAC address corresponding to the logged-on VSAT.

### EFFECT

According to embodiments of the present invention, it is possible to improve stability of a link by installing, in a corresponding site, very small aperture terminals (VSATs) for satellite communication in a duplex configuration, to minimize service interruption due to unstable links, errors in terminals, and the like, in a satellite communication system based on a digital video broadcasting-return channel via satellite (DVB-RCS).

Additionally, according to embodiments of the present invention, stability of a link may be improved and thus, it is possible to stabilize a wide communication zone that may be relayed using a single satellite.

In addition, according to embodiments of the present invention, stability of a link may be improved and thus, it is possible to overcome a geographic bather and to improve disaster tolerance and uniformity of a communication quality.

Furthermore, according to embodiments of the present invention, stability of a link may be improved and thus, it is possible to stabilize possibility of wide-area, high-speed transmission based on use of radio waves in a high-frequency band.

Moreover, according to embodiments of the present invention, stability of a link may be improved and thus, it is possible to stabilize possibility of a multiple access (MA) enabling setting of a line between multiple points and multi-address calling enabling information to be simultaneously distributed to multiple points.

In addition, according to embodiments of the present invention, stability of a link may be improved and thus, it is possible to provide a stable function as a mobile communication base station that enables a line to be freely, quickly set in all locations when an earth station is moved.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating an entire network configured to provide a communication service using a satellite communication system according to an embodiment of the present invention;

FIG. 2 is a block diagram illustrating an internal configuration of a satellite communication system according to an embodiment of the present invention;

FIG. 3 is a flowchart illustrating a satellite communication method according to an embodiment of the present invention; and

FIG. 4 is a flowchart illustrating a satellite communication method according to another embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

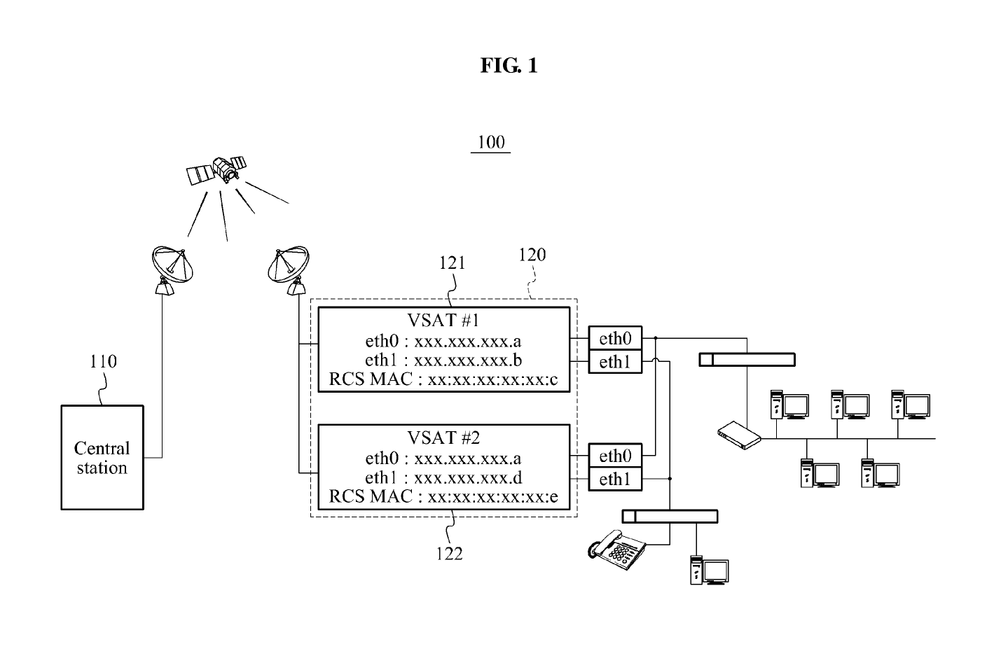

FIG. 1 is a diagram illustrating an entire network 100 configured to provide a communication service using a satellite communication system according to an embodiment of the present invention.

The entire network 100 may provide a satellite communication service using the satellite communication system.

The satellite communication system may include a central station 110, and at least one very small aperture satellite earth station 120, that is, at least one very small aperture terminal (VSAT) 120.

The central station 110 may control an entire system, and may have an interface function of a terminal, such as a facsimile and the like, and a data terminal, such as a telephone, a computer, or a public switched network (PSN). Additionally, the central station 110 may be interpreted as a base station to provide a calling function between various terminals through transmission and reception of data.

The central station 110 may communicate with the at least one VSAT 120.

The central station 110 may communicate with the at least one VSAT 120, using a channel, for example, a service channel, a traffic channel used to transmit and receive data or sound, and the like.

For example, the central station 110 may perform a polling process of transmitting a control message via a service channel, and of checking a state of each base station, for example a communicable capacity or availability of a communication channel, based on a response message received from each base station.

When a calling request to a terminal within a base station is received, the central station 110 may determine whether the base station is communicable, based on information acquired in the polling process.

When communication between both base stations is terminated, and when a communication termination signal is applied via a service channel by a base station that requested the communication, the central station 110 may perform a communication termination process.

The central station 110 may control and manage the entire network 100, and all stations registered in the entire network 100.

The satellite communication system may include the at least one VSAT 120 in a duplex configuration.

The at least one VSAT 120 may include a first VSAT 121, and a second VSAT 122.

The at least one VSAT 120 may be interpreted to be a satellite communication system that may be used by a user in home or company.

To use the at least one VSAT 120, a box used to interface a computer of a user to an external antenna equipped with a transceiver may be required. The transceiver may exchange a signal with a transponder of a satellite floating in the sky. The satellite may exchange a signal with an earth station computer that acts as a hub of a system.

The at least one VSAT 120 may be used by home users who sign up with a large service, such as a direct personal computer (PC), or by private companies that operate their own systems.

When the at least one VSAT 120 is used, a large number of advantages may be provided, in comparison to a terrestrial communication. For example, companies may have their own communication systems, independently of other companies. Business and home users may also acquire a higher reception rate, in comparison to when using an integrated services digital network (ISDN) or an ordinary telephone service.

The satellite communication system may install the at least one VSAT 120 in a single site, and may use the at least one VSAT 120 by changing over the at least one VSAT 120 through the central station 110.

Specifically, when a logon message, that is, a common signaling channel (CSC) is received from the second VSAT 122, VSAT link control software of the central station 110 may determine whether the first VSAT 121 that is logged onto the central station 110 in advance is normally operated.

When the first VSAT 121 is determined to be normally operated, the central station 110 may transmit a transmit disable command to the second VSAT 122. When the first VSAT 121 is determined to be abnormally operated, the central station 110 may allow the second VSAT 122 to log onto the central station 110.

The central station 110 may periodically check a logon state of the second VSAT 122. When a terminal logged onto the central station 110 does not exist, the central station 110 may transmit a wake-up command to each terminal at sequential regular intervals. Conversely, when a terminal logged onto the central station 110 exists, the central station 110 may continue to maintain a current logon state.

The at least one VSAT 120 may activate “eth0” only in a logon state. For example, when a transmit disable signal is received from the central station 110, the logon state may transition to a hold state, and “eth0” may be inactivated.

Subsequently, when a wake-up signal is received from the central station 110, the at least one VSAT 120 may perform a logon process. When the logon process is completed, the at least one VSAT 120 may activate “eth0.”

The central station 110 may perform a terminal changeover function by transmitting a monitoring and control (M&C) message to the at least one VSAT 120. In this instance, “eth0” may be set to have the same Internet protocol (IP), however, “eth1” may be set to have different IPs to prevent an IP conflict.

To process packet data, the central station 110 may use a media access control (MAC) address of a terminal activated when received data is transformed to a moving picture experts group-transport stream (MPEG-TS). Accordingly, duplex terminals may be set to have different MAC addresses.

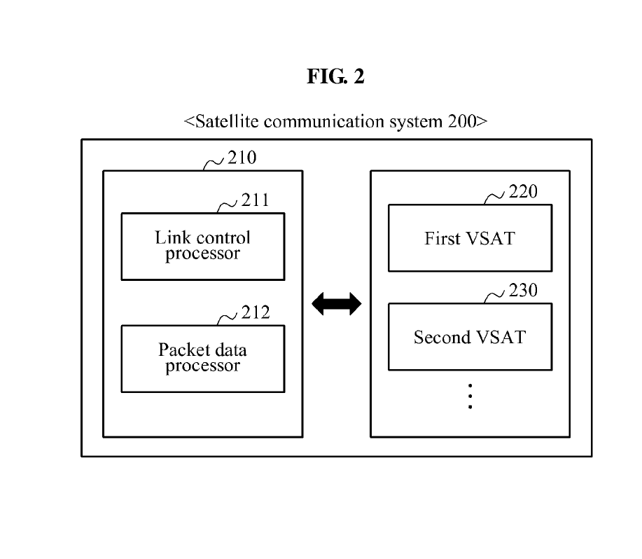

FIG. 2 is a block diagram illustrating an internal configuration of a satellite communication system 200 according to an embodiment of the present invention.

The satellite communication system 200 may include a central station 210, and at least one VSAT.

For convenience of description, the at least one VSAT may include a first VSAT 220 and a second VSAT 230.

The second VSAT 230 may transmit a logon request to the central station 210.

When the logon request is received, the central station 210 may determine whether the first VSAT 220 is normally operated. When the first VSAT 220 is determined to be abnormally operated, the central station 210 may allow the second VSAT 230 to log onto the central station 210.

The first VSAT 220 may be interpreted to be VSAT #1 that is logged onto a central station in advance, and the second VSAT 230 may be interpreted to be VSAT #2 that is one of duplex terminals.

The central station 210 may include a link control processor 211 and a packet data processor 212.

The central station 210 may receive a logon request from the at least one VSAT, through the link control processor 211.

Additionally, when the logon request is received, the central station 210 may determine whether a VSAT that is logged onto the central station 210 in advance is normally operated, through the link control processor 211.

The link control processor 211 may check a logon state of each of the at least one VSAT. When a logged-on VSAT does not exist, the link control processor 211 may transmit a wake-up command to each of the at least one VSAT.

Additionally, the link control processor 211 may set different IPs to each of the at least one VSAT, and may perform a switching function.

The packet data processor 212 may transform received data to an MPEG-TS, using a MAC address corresponding to a VSAT that is currently logged onto the central station 210.

As described above, according to embodiments of the present invention, it is possible to improve stability of a link by installing, in a corresponding site, very small aperture terminals (VSATs) for satellite communication in a duplex configuration, to minimize service interruption due to unstable links, errors in terminals, and the like, in a satellite communication system based on a digital video broadcasting-return channel via satellite (DVB-RCS).

Additionally, according to embodiments of the present invention, stability of a link may be improved and thus, it is possible to stabilize a wide communication zone that may be relayed using a single satellite, to overcome a geographic barrier, and to improve disaster tolerance and uniformity of a communication quality.

Furthermore, according to embodiments of the present invention, stability of a link may be improved and thus, it is possible to stabilize possibility of wide-area, high-speed transmission based on use of radio waves in a high-frequency band.

Moreover, according to embodiments of the present invention, stability of a link may be improved and thus, it is possible to stabilize possibility of a multiple access (MA) enabling setting of a line between multiple points and multi-address calling enabling information to be simultaneously distributed to multiple points.

In addition, according to embodiments of the present invention, stability of a link may be improved and thus, it is possible to provide a stable function as a mobile communication base station that enables a line to be freely, quickly set in all locations when an earth station is moved.

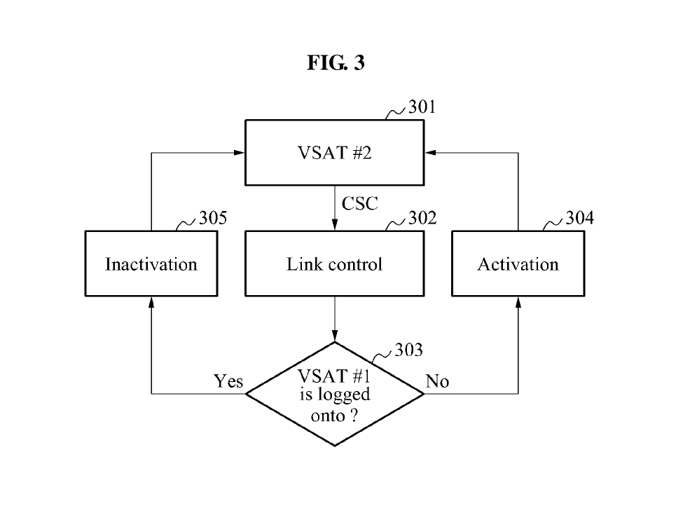

FIG. 3 is a flowchart illustrating a satellite communication method according to an embodiment of the present invention.

Referring to FIG. 3, in operation 301, a communication signal may be collected from a second VSAT, that is, a VSAT #2.

In operation 302, a logon request may be received through a link control function. In operation 303, whether a first VSAT, that is, a VSAT #1 is normally operated may be determined, in response to the logon request.

When the first VSAT is determined to be abnormally operated, transition to an activation state may be performed in operation 304, and logon of the second VSAT may be allowed.

Conversely, when the first VSAT is determined to be normally operated, transition to an inactivation state may be performed in operation 305, and logon of the second VSAT may be allowed.

For example, when the first VSAT is determined to be normally operated, the logon request may be rejected, and a logon state of the first VSAT may be maintained.

Therefore, according to embodiments of the present invention, terminals for satellite communication may be installed in a site in a duplex configuration and thus, it is possible to minimize service interruption due to unstable links, errors in terminals, and the like, and is possible to ensure stability of a link.

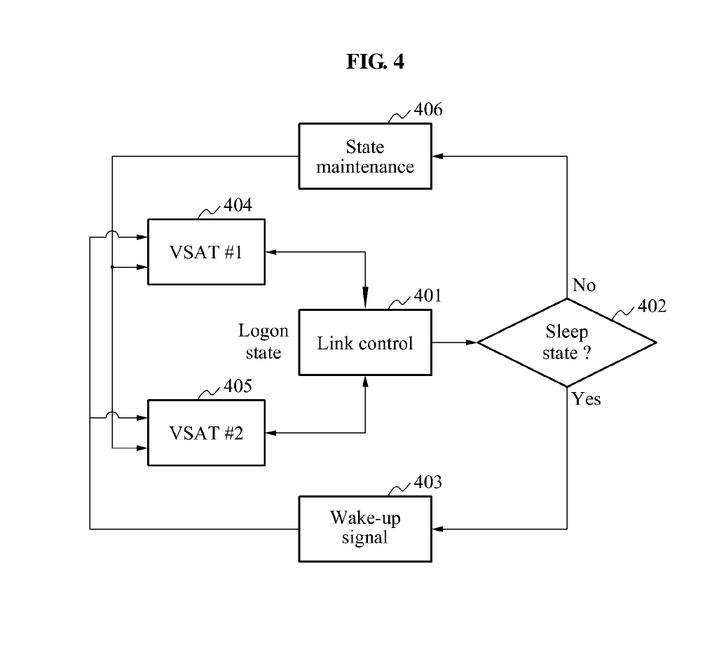

FIG. 4 is a flowchart illustrating a satellite communication method according to another embodiment of the present invention.

Referring to FIG. 4, in operation 401, a logon state of each of VSAT #1 and VSAT #2 may be periodically checked using a link control function of a central station. The VSAT #1 and VSAT #2 may be installed in a duplex configuration.

In operation 402, whether both the VSAT #1 and VSAT #2 are in a sleep state, that is, whether a terminal logged onto the central station does not exist may be determined

For example, when both the VSAT #1 and VSAT #2 are determined to be in the sleep state, wake-up commands may be sequentially transmitted to the VSAT #1 and VSAT to #2 at regular intervals in operation 403.

Conversely, when both the VSAT #1 and VSAT #2 are determined not to be in the sleep state, a current state of each of the VSAT #1 and VSAT #2 may be continuously maintained in operation 406.

Subsequently, each of the VSAT #1 and VSAT #2 may notify a module of a logon state of each of the VSAT #1 and VSAT #2, using the link control function. The module may be used to process the link control function.

The above-described embodiments of the present invention may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the embodiments, or they may be of the kind well-known and available to those having skill in the computer software arts. Examples of non-transitory computer-readable media include magnetic media such as hard disks, floppy disks, and magnetic tape; optical media such as CD ROM disks and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A satellite communication system based on a digital video broadcasting-return channel via satellite (DVB-RCS), the satellite communication system comprising:
a central station; and
at least one very small aperture terminal (VSAT) comprising a first VSAT and a second VSAT,
wherein, when a logon request is received from the second VSAT, the central station determines whether the first VSAT is normally operated, and when the first VSAT is determined to be abnormally operated, the central station allows the second VSAT to log onto the central station.

2. The satellite communication system of claim 1, wherein the central station comprises a link control processor to receive a logon request from the at least one VSAT.

3. The satellite communication system of claim 2, wherein, when the logon request is received, the link control processor determines whether a VSAT that is logged onto the central station in advance is normally operated.

4. The satellite communication system of claim 2, wherein the link control processor checks a logon state of the at least one VSAT, and
wherein, when a VSAT logged onto the central station does not exist, the link control processor transmits a wake-up command to each of the at least one VSAT.

5. The satellite communication system of claim 2, wherein the link control processor sets different Internet protocols (IPs) to the at least one VSAT, and performs a switching function.

6. The satellite communication system of claim 2, wherein the central station comprises a packet data processor to transform received data to a moving picture experts group-transport stream (MPEG-TS), using a media access control (MAC) address corresponding to a currently logged-on VSAT.

7. A satellite communication method based on a digital video broadcasting-return channel via satellite (DVB-RCS), the satellite communication method comprising:
receiving a logon request from a second very small aperture terminal (VSAT);
determining whether a first VSAT is normally operated, in response to the logon request; and
allowing the second VSAT to log onto a central station, when the first VSAT is determined to be abnormally operated.

8. The satellite communication method of claim 7, further comprising:
rejecting the logon request, and maintaining a logon state of the first VSAT, when the first VSAT is determined to be normally operated.

9. A satellite communication method based on a digital video broadcasting-return channel via satellite (DVB-RCS), the satellite communication method comprising:
checking a logon state of each of a plurality of very small aperture terminals (VSATs) corresponding to a central station;
determining whether a VSAT logged onto the central station exists among the plurality of VSATs; and
transmitting a wake-up command to each of the plurality of VSATs, when the logged-on VSAT is determined not to exist.

10. The satellite communication method of claim 9, further comprising:
maintaining a current state of each of the plurality of VSATs, when the logged-on VSAT is determined to exist.

11. The satellite communication method of claim 10, further comprising:
transforming received data to a moving picture experts group-transport stream (MPEG-TS), using a media access control (MAC) address corresponding to the logged-on VSAT.
